(19) United States
(12) Patent Application Publication
(10) Pub. No.: US 2018/0341427 A1
(43) Pub. Date: Nov. 29, 2018

(54) METHOD AND APPARATUS FOR MANAGING STORAGE SPACE, AND ELECTRONIC DEVICE

(71) Applicant: BEIJING KINGSOFT INTERNET SECURITY SOFTWARE CO., LTD., Beijing (CN)

(72) Inventor: Ruiqi Wang, Beijing (CN)

(73) Assignee: BEIJING KINGSOFT INTERNET SECURITY SOFTWARE CO., LTD., Beijing (CN)

(21) Appl. No.: 16/047,775

(22) Filed: Jul. 27, 2018

Related U.S. Application Data
(63) Continuation of application No. PCT/CN2017/080968, filed on Apr. 18, 2017.

(30) Foreign Application Priority Data
Apr. 27, 2016 (CN) 201610274294.6

(51) Int. Cl. G06F 3/06

(52) U.S. Cl. CPC G06F 3/0653; G06F 3/0652; G06F 3/0673; G06F 3/0604

(57) ABSTRACT

The present disclosure provides a method and an apparatus for managing storage space and an electronic device. The method includes: obtaining a first operation instruction for managing storage space, in which the first operation instruction is configured to instruct to display a storage space management window; displaying the storage space management window, and displaying newly added storage amounts of respective applications within a preset time period in the storage space management window, in which the preset time period is from the last time of displaying the storage space management window before deleting data in the storage space to this time of displaying the storage space management window.

### CROSS-REFERENCE TO RELATED APPLICATION

The present application is a continuation application of International Application No. PCT/CN2017/080968, filed with the State Intellectual Property Office of P. R. China on Apr. 18, 2017, which is based upon and claims priority to Chinese Patent Application No. 201610274294.6, filed on Apr. 27, 2016, the entire contents of each of which are incorporated herein by reference.

### FIELD

The present disclosure relates to a field of mobile terminal technology, and more specifically to a method for managing storage space, an apparatus for managing storage space, and an electronic device.

### BACKGROUND

At present, mobile terminals such as smart phones and tablet computers are installed with massive applications, for instance, audio video, music, picture, and chat applications. With usage of the mobile terminal by a user, more and more files are saved in storage space of the mobile terminal, and if deletion and other management operations are not executed for a long time, it may result in that the storage space is insufficient.

When there is a need to manage storage space, for example delete unneeded files or junk files, a storage space management window is invoked, and information of space used by respective applications is displayed in the window. When the user chooses a certain application, details of the information of space used by the application is displayed, and the user may selectively delete data saved by the application on demand.

During research and practice, inventors of the present disclosure discover that, the information of space used by respective applications displayed in the storage space management window includes total storage space sizes used by respective applications, for example, it may be displayed in the storage space management window that storage space used by photo application is 1.2 GB, storage space used by Wechat application is 600 MB, storage space used by Douban application is 80 MB and the like. It should be noted that, although some applications use a larger total storage space, these applications using the larger storage space are not focus on which deletion operations are performed when managing files. For example, the picture application saves photos taken by the user in daily use, which usually uses more storage space, but the saved pictures may be pictures that have been selected and need to be saved for a long time. Therefore, the information displayed in the storage space management window is not perfect for guiding the deletion operation when managing files. When the unneeded files are deleted to manage the space of the terminal, the user may first perform data cleaning of the application using the largest storage space according to a display result of the storage space management window. However, when cleanable space of the application using the largest storage space is not large, the user may need to open massive applications and execute the deletion operation one by one, so as to free more space, which costs a very long time. Although some applications do not use the largest space, they save massive junk files, which is not easy to be found based on the current display result.

### SUMMARY

Embodiments of the present disclosure provide a method and an apparatus for managing storage space, and an electronic device, which are advantageous to provide more effective reference information for a user to manage storage space.

A first aspect of embodiments of the present disclosure provides a method for managing storage space, including:

obtaining a first operation instruction for managing storage space, in which the first operation instruction is configured to instruct to display a storage space management window;

displaying the storage space management window, and displaying newly added storage amounts of respective applications within a preset time period in the storage space management window, in which the preset time period is from the last time of displaying the storage space management window before deleting data in the storage space to this time of displaying the storage space management window.

A second aspect of embodiments of the present disclosure provides an apparatus for managing storage space, including:

a first obtaining unit, configured to obtain a first operation instruction for managing storage space, in which the first operation instruction is configured to instruct to display a storage space management window;

a first display unit, configured to display the storage space management window, and display newly added storage amounts of respective applications within a preset time period in the storage space management window, in which the preset time period is from the last time of displaying the storage space management window before deleting data in the storage space to this time of displaying the storage space management window.

A third aspect of embodiments of the present disclosure provides an electronic device, including: a processor, a memory, a communication interface and a bus, in which,

the processor, the memory and the communication interface are connected with each other and communicate with each other via the bus;

the memory is configured to store executable program codes;

the processor is configured to run a program corresponding to the executable program codes by reading the executable program codes stored in the memory, to execute a method for managing storage space, in which, the method includes:

obtaining a first operation instruction for managing storage space, in which the first operation instruction is configured to instruct to display a storage space management window;

displaying the storage space management window, and displaying newly added storage amounts of respective applications within a preset time period in the storage space management window, in which, the preset time period is from the last time of displaying the storage space management window before deleting data in the storage space to this time of displaying the storage space management window.

A fourth aspect of embodiments of the present disclosure provides a storage medium, in which, the storage medium is configured to store application programs, and the application programs are configured to execute a method for managing storage space according to embodiments of the present disclosure when running.

### BRIEF DESCRIPTION OF THE DRAWINGS

In order to more clearly explain technical solutions of embodiments of the present disclosure, drawings required to be used in description of embodiments of the present disclosure is simply introduced below. Apparently, the drawings in the following description are merely embodiments of the present disclosure. For the ordinary skilled in the art, other drawings may be obtained based on these drawings without any creative work.

FIG. 1 is a flow chart illustrating a method for managing storage space provided by an embodiment of the present disclosure.

FIG. 2 is a flow chart illustrating a method for managing storage space provided by another embodiment of the present disclosure.

FIG. 3-a is a schematic diagram illustrating an apparatus for managing storage space provided by an embodiment of the present disclosure.

FIG. 3-b is a schematic diagram illustrating a storage space management window provided by embodiments of the present disclosure.

FIG. 3-c is a storage file information window corresponding to Wechat in FIG. 3-b;

FIG. 3-d is a storage file information window corresponding to Wechat in FIG. 3-b;

FIG. 4 is a block diagram illustrating an apparatus for managing storage space provided by another embodiment of the present disclosure.

FIG. 5 is a block diagram illustrating an apparatus for managing storage space provided by another embodiment of the present disclosure.

FIG. 6 is a schematic diagram illustrating an electronic device provided by an embodiment of the present disclosure.

### DETAILED DESCRIPTION

Embodiments of the present disclosure provide a method for managing storage space, an apparatus for managing storage space and an electronic device thereof, which may provide more effective reference information for a user to manage storage space, and improve file management efficiency.

In order to enable those skilled in the art to better understand solutions of the present disclosure, the technical solutions in embodiments of the present disclosure will be described clearly and completely below with reference to the drawings in embodiments of the present disclosure. Apparently, embodiments described are a part of embodiments of the present disclosure, and not all of embodiments. Based on embodiments disclosed in the present disclosure, all other embodiments obtained by the ordinary skilled in the art without creative work should fall within the protection scope of the present disclosure.

Detailed description will be made below.

Terms “first”, “second”, “third”, and “fourth” and the like in the specification and claims of the present disclosure and in the above drawings are used to distinguish different objects, but are not used to describe a specific order. In addition, terms such as “including” and “having” and any other variations thereof are intended to cover non-exclusive inclusion. For instance, an operation, a method, a system, a product, or a device including a serious of steps or units is not limited to the steps or units which have been listed, and alternatively further includes steps and units which have not been listed, or alternatively further includes other steps and units inherent to the operation, method, product, or device.

The present disclosure provides a method for managing storage space, which may include: obtaining a first operation instruction for managing storage space, in which, the first operation instruction is configured to instruct to display a storage space management window; displaying the storage space management window, and displaying newly added storage amounts of respective applications within a time period in the storage space management window, in which the time period is from the last time of displaying the storage space management window before deleting data in the storage space to this time of displaying the storage space management window.

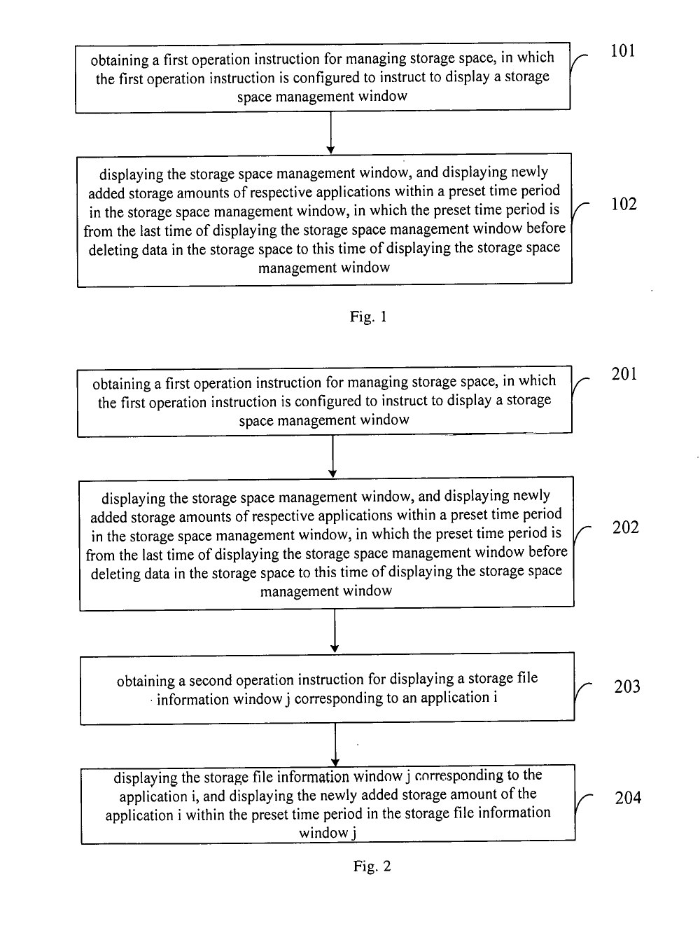

Please refer to FIG. 1, which is a flow chart illustrating a method for managing storage space provided by an embodiment of the present disclosure. As illustrated in FIG. 1, the method for managing storage space provided by an embodiment of the present disclosure may include following operations.

At 101, a first operation instruction for managing storage space is obtained, in which the first operation instruction is configured to instruct to display a storage space management window.

Alternatively, in some possible implementations of the present disclosure, when a user wishes to manage storage space of a terminal device, the user may send the first operation instruction by operating the terminal. For example, the first operation instruction may be triggered by the user through double clicking an icon of a storage space management software in the desktop of the terminal device.

Alternatively, in some possible implementations of the present disclosure, the first operation instruction may be triggered and generated by the terminal device when the terminal device detects that free storage space is less than a preset threshold. For example, when detecting that free storage space in the terminal device is less than 500 MB, the terminal device automatically generates the first operation instruction. As another example, when detecting that free storage space in the terminal device is less than 5% of the total storage space, the terminal device automatically generates the first operation instruction. Of course, the first operation instruction may further be triggered and generated by the terminal device when the terminal device detects that used storage space is more than the preset threshold. For example, when the terminal device detects that used storage space in the terminal device is more than 3 GB, the terminal device automatically triggers to generate the first operation instruction. As another example, when detecting that used storage space in the terminal device is more than 80% of the total storage space, the terminal device automatically generates the first operation instruction.

Alternatively, in some possible implementations of the present disclosure, the first operation instruction may further be preset by the terminal device, which is automatically generated at a preset time. For example, it may be set that the terminal device manages storage space of the terminal device at 9 pm every Monday, and then the terminal device automatically generates the first operation instruction at 9 pm every Monday.

The terminal device may be a personal computer, a personal digital assistant, a multiplayer interactive device, a smart phone, a table computer or any other product form of terminal devices.

At 102, the storage space management window is displayed, and newly added storage amounts of respective applications within a preset time period are displayed in the storage space management window, in which, the preset time period is from the last time of displaying the storage space management window before deleting data in the storage space to this time of displaying the storage space management window.

For example, if the applications installed in the terminal device include A, B and C, and if this time of displaying the storage space management window is at 4:00 PM on Apr. 14, 2016, and the last time of displaying the storage space management window before deleting data in the storage space is at 9:00 PM on Mar. 29, 2016, then in the storage space management window, respective newly added storage amounts of the applications A, B and C during 9:00 PM on Mar. 29, 2016 to 4:00 PM on Apr. 14, 2016 are displayed. For example, if the newly added storage amounts of the applications A, B and C within the time period mentioned above are respectively 400 MB, 180 MB and 190 MB, the respective newly added storage amounts of the applications A, B and C are displayed in displayed storage space management window.

It should be noted that, in the displayed storage space management window, it may display detailed information corresponding to the time period from the last time of displaying the storage space management window before deleting data in the storage space to this time of displaying the storage space management window, for example, it may display “from 9:00 PM on Mar. 29, 2016 to 4:00 PM on Apr. 14, 2016”, or may merely display “latest 16 days”, or it may also not display information of the time period and merely display information such as the newly added storage amounts.

It should be noted that, if no deletion operation is executed for the data in the storage space after the latest time of displaying the storage space management window before this time of displaying the storage space management window, it is determined whether the data in the storage space is deleted after the second to last time of displaying the storage space management window, if the deletion operation is executed, it is “the last time of displaying the storage space management window before deleting data in the storage space”, and if the data in storage space is not deleted, it is continuously determined whether the data in the storage space is deleted after the third to last time of displaying the storage space management window, until the data in the storage space is deleted after a certain time of displaying the storage space management window. It should be noted that, the starting point of the time period may be the time corresponding to displaying the storage space management window, and may also be the time before or after the time corresponding to displaying the storage space management window, for example, it may be the time when executing deleting data, or the time receiving the first operation instruction and the like.

Alternatively, in some possible implementations of the present disclosure, respective applications may be displayed in the storage space management window according to a descending order of the newly added storage amounts. If the newly added storage amounts of the applications A, B and C are respectively 400 MB, 180 MB and 190 MB, the newly added storage amounts of the respective applications are displayed in the order of A, C, B when the newly added storage amounts of the applications A, B and C are displayed in the displayed storage space management window.

It can be seen that, with the technical solutions provided by embodiments of the present disclosure, the newly added storage amounts of respective applications within the time period which is from the last time of displaying the storage space management window before deleting data in the storage space to this time of displaying the storage space management window are displayed in the storage space management window. The newly added storage amounts have a stronger reference value for the user to manage storage space, which is advantageous to improve file management efficiency.

Please refer to FIG. 2, which is a flow chart illustrating a method for managing storage space provided by another embodiment of the present disclosure. As illustrated in FIG. 2, the method for managing storage space provided by another embodiment of the present disclosure may include the following operations.

At 201, a first operation instruction for managing storage space is obtained, in which the first operation instruction is configured to instruct to display a storage space management window.

Alternatively, in some possible implementations of the present disclosure, when a user wishes to manage storage space of a terminal device, the user may send the first operation instruction by operating the terminal. For example, the first operation instruction may be triggered by the user through double clicking an icon of a storage space management software in the desktop of the terminal device.

Alternatively, in some possible implementations of the present disclosure, the first operation instruction may be triggered and generated by the terminal device when the terminal device detects that free storage space is less than a preset threshold. For example, when detecting that free storage space in the terminal device is less than 500 MB, the terminal device automatically generates the first operation instruction. As another example, when detecting that free storage space in the terminal device is less than 5% of the total storage space, the terminal device automatically generates the first operation instruction. Of course, the first operation instruction may further be triggered and generated by the terminal device when the terminal device detects that free storage space is more than the preset threshold. For example, when the terminal device detects that used storage space in the terminal device is more than 1 GB, the terminal device automatically triggers to generate the first operation instruction. As another example, when detecting that used storage space in the terminal device is more than 80% of the total storage space, the terminal device automatically generates the first operation instruction.

Alternatively, in some possible implementations of the present disclosure, the first operation instruction may further be preset by the terminal device, which is automatically generated at a preset time. For example, it may be set that the terminal device manages storage space of the terminal device at 9 pm every Monday, and then the terminal device automatically generates the first operation instruction at 9 pm every Monday.

At 202, the storage space management window is displayed, and newly added storage amounts of respective applications within a preset time period are displayed in the storage space management window, in which, the preset time period is from the last time of displaying the storage space management window before deleting data in the storage space to this time of displaying the storage space management window.

For example, if the applications installed in the terminal device include A, B and C, and if this time of displaying the storage space management window is at 4:00 PM on Apr. 14, 2016, and the last time of displaying the storage space management window before deleting data in the storage space is at 9:00 PM on Mar. 29, 2016, then in the storage space management window, respective newly added storage amounts of the applications A, B and C during 9:00 PM on Mar. 29, 2016 to 4:00 PM on Apr. 14, 2016 are displayed. For example, if the newly added storage amounts of the applications A, B and C within the time period mentioned above are respectively 400 MB, 180 MB and 190 MB, the respective newly added storage amounts of the applications A, B and C are displayed in displayed storage space management window.

At 203, a second operation instruction for displaying a storage file information window j corresponding to an application i is obtained.

The application i is any of the applications displayed in the storage space management window. For example, if the newly added storage amounts of the applications A, B and C are included in the storage space management window, a second operation instruction may be double clicking on a names and/or an icon of any application. For instance, if the name of the application A is double clicked, it is configured to trigger to display the storage file information window corresponding to the application A.

At 204, the storage file information window j corresponding to the application i is displayed, and the newly added storage amount of the application i within the preset time period is displayed in the window j.

It can be seen that, with the technical solutions provided by embodiments of the present disclosure, the newly added storage amounts of respective applications within the time period which is from the last time of displaying the storage space management window before deleting data in the storage space to this time of displaying the storage space management window are displayed in the storage space management window. Moreover, when the storage file information window of a certain application is triggered to display, the newly added storage amounts of the storage files corresponding to the application is displayed in the storage file information window. In this way, it has a stronger reference value for the user to manage storage space, which is advantageous to improve file management efficiency.

Alternatively, in some possible implementations of the present disclosure, in order to improve the file management efficiency, if the application i corresponds to a plurality of storage files, the storage file information window j may include at least one control button configured to delete data in a certain storage file. For examples, if the application i corresponds to a cache file, a temporary file, and an image file, the storage file information window j corresponding to the application i may include two control buttons configured to delete data in the storage files, for example, a control button 1 and a control button 2, in which, the control button 1 is configured to delete data in the cache file, and the control button 2 is configured to delete data in the temporary file. The data in the cache file may be deleted at one time, and the data in the temporary file may be deleted at one time. For the image file, the images needed to be deleted may be deleted one by one after browsing. Of course, in order to facilitate the user to identify the images needed to be deleted, newly added images may be highlighted in a specific way, for example, with a border of a specific color, with a file name of a specific color, or with a dot marked in the image, and the like. In this way, it can facilitate the user to identify the images needed to be deleted, which is advantageous to improve the file management efficiency.

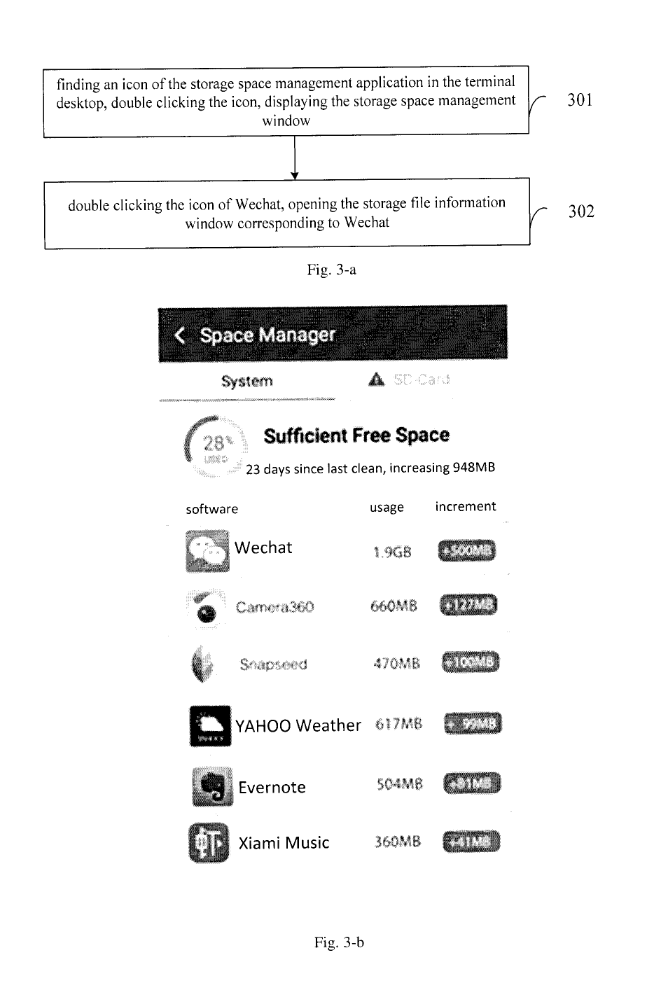

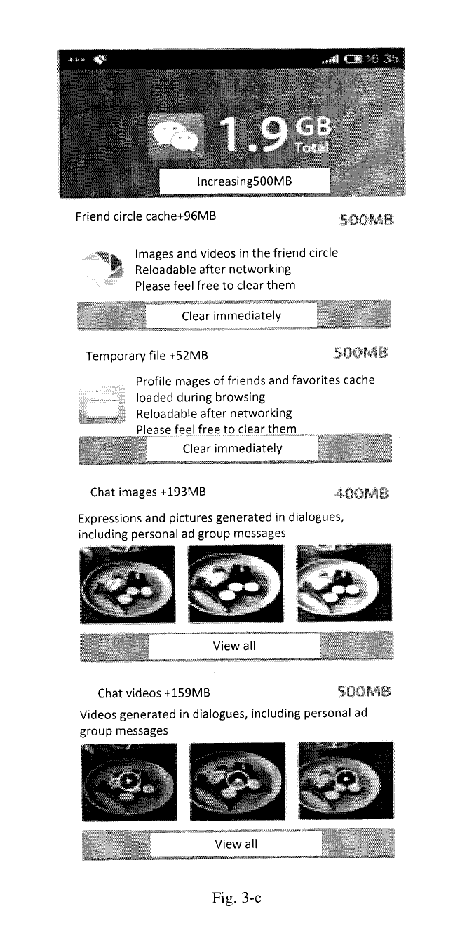

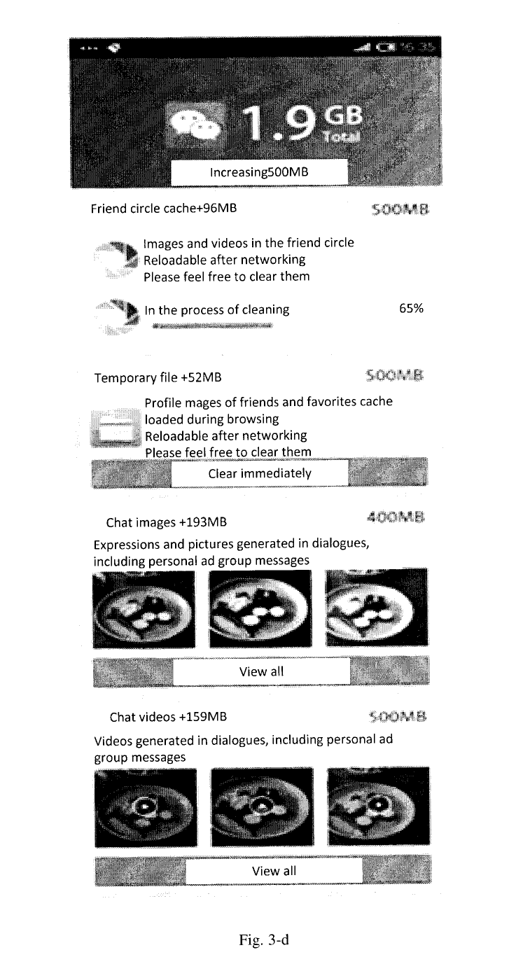

In the following, a smart phone is taken as an example, and storage space in the smart phone is managed. Specifically, please referring to FIG. 3-a, which is a schematic diagram illustrating a method for managing storage space provided by another embodiment of the present disclosure, the method for managing storage space provided by this embodiment may include the following operations.

At 301, an icon of a storage space management application is found in a terminal desktop, the icon of the application is double clicked, and the storage space management window is displayed.

In detail, the displayed storage space management window is as illustrated in FIG. 3-b. In the storage space management window, it displays that the corresponding time period from the last time of displaying the storage space management window before deleting data in storage space to this time of displaying the storage space management window is 23 days. Specifically, the displayed content is: 23 days since last data clean. Storage space of the mobile terminal has been used by 28%, and the newly added storage amount in the last 23 days is 948 MB. As illustrated in FIG. 3-b, the applications are arranged according to a descending order of the newly added storage amounts of the applications, in which, storage space used by Wechat is 1.9 GB, the increment in the last 23 days is 500 MB; storage space used by Camera360 application is 660 MB, the increment in the last 23 days is 127 MB; storage space used by Snapseed application is 470 MB, the increment in the last 23 days is 100 MB; storage space used by YAHOO weather application is 617 MB, the increment in the last 23 days is 99 MB; storage space used by Evemote is 504 MB, the increment in the last 23 days is 81 MB; storage space used by XiaMi Music is 360 MB, the increment in the last 23 days is 41 MB.

At 302, the icon of Wechat is double clicked to open the storage file information window corresponding to Wechat.

The storage file information window corresponding to Wechat is as illustrated in FIG. 3-c, in which it is displayed that the total amount of storage space used by Wechat is 1.9 GB, and the increment in the last 23 days is 500 MB. It can seen from FIG. 3-c that, there are four files included in Wechat, which are friend circle cache, temporary file, chat images, and chat videos, respectively. In detail, storage space used by friend circle cache is 500 MB, the increment in the last 23 days is 96 MB; storage space used by temporary file is 500 MB, the increment in the last 23 days is 52 MB; storage space used by chat images is 400 MB, the increment in the last 23 days is 193 MB; storage space used by chat videos is 500 MB, the increment in the last 23 days is 159 MB.

When storage space of Wechat is managed, since the friend circle cache saves images and videos in the friend circle of Wechat, which can be reloaded after networking, terminal files in the friend circle cache may be cleared. Similarly, the temporary file save profile images of friends and favorites cache when Wechat is browsed, which can be reloaded after networking, and thus the files in the temporary file may be cleared. As illustrated in FIG. 3-c, a control button for immediate clean-up is provided under each of the friend circle cache icon and the temporary file icon. When the control button for immediate clean-up under the friend circle cache icon is clicked, data in the friend circle cache may be cleared. When the control button for immediate clean-up under the temporary file icon is clicked, data in the temporary file may be cleared. For example, after clicking the control button for immediate clean-up under the friend circle cache icon, the storage file information window corresponding to Wechat is illustrated as in FIG. 3-d, which displays that data in the friend circle cache is cleaned up, specifically, displays that it is in the cleaning and the progress of the cleaning, as illustrated in FIG. 3-d, it is in the process of cleaning the friend circle cache, and the progress of cleaning is 65%. It should be noted that, since data in the chat images and the chat videos usually save data that the user wants to keep, the two files are not provided with the control button for immediate clean-up. When the files in these two files need to be cleared, a view all control button under the corresponding icon may be clicked. For instance, when the chat images need to be cleared, the view all control button under the corresponding icon is clicked, and then the image folder is open and all the images in the image folder can be viewed. Alternatively, in some possible implementation of the present disclosure, it is possible to mark the images newly added in the last 23 days in the open chat image file, such as adding color to the border of the image, using a different color in the file name of the image, or setting a mark on the image, such as superposing a red dot on the image, which is advantageous for the user to identify what are the newly added images in time, thus improving the speed that the user manages images.

Of course, when storage space of applications other than Wechat is managed, operations are similar, which will not be elaborated herein.

It can be seen that, with the technical solution provided by embodiments of the present disclosure, the newly added storage amounts of respective applications within the time period which is from the last time of displaying the storage space management window before deleting data in the storage space to this time of displaying the storage space management window are displayed in the storage space management window. Moreover, when the storage file information window of a certain application is triggered to display, the newly added storage amount of the storage files corresponding to the application is displayed in the storage file information window. In this way, it has a stronger reference value for the user to manage storage space, which is advantageous to improve file management efficiency.

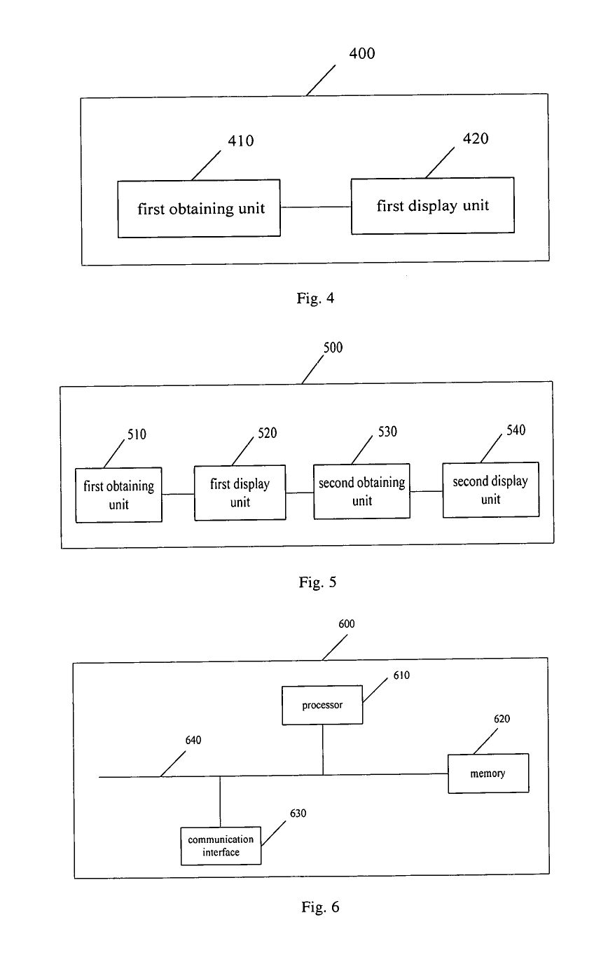

Please refer to FIG. 4, which is a block diagram illustrating an apparatus for managing storage space provided by an embodiment of the present disclosure. As illustrated in FIG. 4, the apparatus 400 for managing storage space provided by an embodiment of the present disclosure may include a first obtaining unit 410 and a first display unit 420.

The first obtaining unit 410 is configured to obtain a first operation instruction for managing storage space, in which the first operation instruction is configured to instruct to display a storage space management window.

Alternatively, in some possible implementations of the present disclosure, when a user wishes to manage storage space of a terminal device, the user may send the first operation instruction by operating the terminal. For example, the first operation instruction may be triggered by the user through double clicking an icon of a storage space management software in the desktop of the terminal device.

Alternatively, in some possible implementations of the present disclosure, the first operation instruction may be triggered and generated by the terminal device when the terminal device detects that free storage space is less than a preset threshold. For example, when detecting that free storage space in the terminal device is less than 500 MB, the terminal device automatically generates the first operation instruction. As another example, when detecting that free storage space in the terminal device is less than 5% of the total storage space, the terminal device automatically generates the first operation instruction. Of course, the first operation instruction may further be triggered and generated by the terminal device when the terminal device detects that used storage space is more than the preset threshold. For example, when the terminal device detects that used storage space in the terminal device is more than 3 GB, the terminal device automatically triggers to generate the first operation instruction. As another example, when detecting that used storage space in the terminal device is more than 80% of the total storage space, the terminal device automatically generates the first operation instruction.

Alternatively, in some possible implementations of the present disclosure, the first operation instruction may further be preset by the terminal device, which is automatically generated at a preset time. For example, it may be set that the terminal device manages storage space of the terminal device at 9 pm every Monday, and then the terminal device automatically generates the first operation instruction at 9 pm every Monday.

The first display unit 420 is configured to display the storage space management window, and display newly added storage amounts of respective applications within a preset time period in the storage space management window, in which, the preset time period is from the last time of displaying the storage space management window before deleting data in the storage space to this time of displaying the storage space management window.

For example, if the applications installed in the terminal device include A, B and C, and if this time of displaying the storage space management window is at 4:00 PM on Apr. 14, 2016, and the last time of displaying the storage space management window before deleting data in the storage space is at 9:00 PM on Mar. 29, 2016, then in the storage space management window, respective newly added storage amounts of the applications A, B and C during 9:00 PM on Mar. 29, 2016 to 4:00 PM on Apr. 14, 2016 are displayed. For example, if the newly added storage amounts of the applications A, B and C within the time period mentioned above are respectively 400 MB, 180 MB and 190 MB, the respective newly added storage amounts of the applications A, B and C are displayed in displayed storage space management window.

Alternatively, in some possible implementations of the present disclosure, the respective applications may be displayed in the storage space management window based on a descending order of the newly added storage amounts. If the newly added storage amounts of the applications A, B and C are respectively 400 MB, 180 MB and 190 MB, the newly added storage amounts of respective applications are displayed in the order of A, C, B when the newly added storage amounts of the applications A, B and C are displayed in displayed storage space management window.

It can be seen that, with the technical solution provided by embodiments of the present disclosure, the newly added storage amounts of the respective applications within the time period from this time of obtaining the first operation instruction to the last time of obtaining the first operation instruction and managing storage space are displayed in the storage space management window. The newly added storage amounts have a stronger reference value for the user to manage storage space, which is advantageous to improve file management efficiency.

Please refer to FIG. 5, which is a block diagram illustrating an apparatus for managing storage space provided by another embodiment of the present disclosure. As illustrated in FIG. 5, the apparatus 500 for managing storage space provided by the embodiment of the present disclosure may include a first obtaining unit 510, a first display unit 520, a second obtaining unit 530 and a second display unit 540.

The first obtaining unit 510 is configured to obtain a first operation instruction for managing storage space, in which the first operation instruction is configured to instruct to display a storage space management window.

Alternatively, in some possible implementations of the present disclosure, when a user wishes to manage storage space of a terminal device, the user may send the first operation instruction by operating the terminal. For example, the first operation instruction may be triggered by the user through double clicking an icon of a storage space management software in the desktop of the terminal device.

Alternatively, in some possible implementations of the present disclosure, the first operation instruction may be triggered and generated by the terminal device when the terminal device detects that free storage space is less than a preset threshold. For example, when detecting that free storage space in the terminal device is less than 500 MB, the terminal device automatically generates the first operation instruction. As another example, when detecting that free storage space in the terminal device is less than 5% of the total storage space, the terminal device automatically generates the first operation instruction. Of course, the first operation instruction may further be triggered and generated by the terminal device when the terminal device detects that used storage space is more than the preset threshold. For example, when the terminal device detects that used storage space in the terminal device is more than 1 GB, the terminal device automatically triggers to generate the first operation instruction. As another example, when detecting that used storage space in the terminal device is more than 80% of the total storage space, the terminal device automatically generates the first operation instruction.

Alternatively, in some possible implementations of the present disclosure, the first operation instruction may further be preset by the terminal device, which is automatically generated at a preset time. For example, it may be set that the terminal device manages storage space of the terminal device at 9 pm every Monday, and then the terminal device automatically generates the first operation instruction at 9 pm every Monday.

The first display unit 520 is configured to display the storage space management window, and display newly added storage amounts of respective applications within a preset time period in the storage space management window, in which, the preset time period is from the last time of displaying the storage space management window since deleting data in the storage space to this time of displaying the storage space management window.

For example, if the applications installed in the terminal device include A, B and C, and if this time of displaying the storage space management window is at 4:00 PM on Apr. 14, 2016, and the last time of displaying the storage space management window since deleting data in the storage space is at 9:00 PM on Mar. 29, 2016, then in the storage space management window, respective newly added storage amounts of the applications A, B and C during 9:00 PM on Mar. 29, 2016 to 4:00 PM on Apr. 14, 2016 are displayed. For example, if the newly added storage amounts of the applications A, B and C within the time period mentioned above are respectively 400 MB, 180 MB and 190 MB, the respective newly added storage amounts of the applications A, B and C are displayed in the displayed storage space management window.

The second obtaining unit 530 is configured to obtain a second operation instruction for displaying a storage file information window j corresponding to an application i after the first display unit displays the storage space management window, in which, the application i is any of the applications displayed in the storage space management window.

In detail, the application i is any of the applications displayed in the storage space management window. For example, if the newly added storage amounts of the applications A, B and C are included in the storage space management window, a second operation instruction may be double clicking on a names and/or an icon of any application. For instance, if the name of the application A is double clicked, it is configured to trigger to display the storage file information window corresponding to the application A.

The second display unit 540 is configured to display the storage file information window j corresponding to the application i, and display a newly added storage amount of the application i within the preset time period in the storage file information window j.

It can be seen that, with the technical solution provided by embodiments of the present disclosure, the newly added storage amounts of respective applications within the time period which is from the last time of displaying the storage space management window before deleting data in the storage space to this time of displaying the storage space management window are displayed in the storage space management window. Moreover, when the storage file information window of a certain application is triggered to display, the newly added storage amounts of the storage files corresponding to the application are displayed in the storage file information window. In this way, it has a stronger reference value for the user to manage storage space, which is advantageous to improve file management efficiency.

Alternatively, in some possible implementations of the present disclosure, in order to improve the file management efficiency, the second display unit 540 is configured to, if the application i corresponds to a plurality of storage files, display in the storage file information window j, at least one control button configured to delete data in a certain storage file. For example, if the application i corresponds to a cache file, a temporary file, and an image file the storage file information window j corresponding to the application i may include two control buttons configured to delete data in the storage files, for example, a control button 1 and a control button 2, in which, the control button 1 is configured to delete data in the cache file, and the control button 2 is configured to delete data in the temporary file. The data in the cache file may be deleted at one time, and the data in the temporary file may be deleted at one time. For the image file, the images needed to be deleted may be deleted one by one after browsing. Of course, in order to facilitate the user to identify the images needed to be deleted, newly added images may be highlighted in a specific way, for example, with a border of a specific color, with a file name of a specific color, or with a dot marked in the image, and the like. In this way, it can facilitate the user to identify the images needed to be deleted, which is advantageous to improve the file management efficiency.

Referring to FIG. 6, which is a block diagram illustrating an electronic device provided by embodiments of the present disclosure, the electronic device 600 may include a processor 610, a memory 620, a communication interface 630 and a bus 640.

The processor 610, the memory 620 and the communication interface 630 are connected with each other and communicate with each other via the bus 640.

The memory 620 is configured to store executable program codes.

The processor 610 is configured to run a program corresponding to the executable program codes by reading the executable program codes stored in the memory 620, to execute a method for managing storage space, in which the method for managing storage space includes:

obtaining a first operation instruction for managing storage space, wherein the first operation instruction is configured to instruct to display a storage space management window; and

displaying the storage space management window, and displaying newly added storage amounts of respective applications within a preset time period in the storage space management window, in which, the preset time period is from the last time of displaying the storage space management window before deleting data in the storage space to this time of displaying the storage space management window.

It can be seen that, with the technical solution provided by embodiments of the present disclosure, the newly added storage amounts of respective applications within the time period which is from the last time of displaying the storage space management window before deleting data in the storage space to this time of displaying the storage space management window are displayed in the storage space management window. The newly added storage amounts have a stronger reference value for the user to manage storage space, which is advantageous to improve file management efficiency.

Embodiments of the present disclosure further provide a storage medium. The storage medium is configured to store a program, in which the program is configured to execute the method for managing storage space in embodiments of the present disclosure when the program is running.

Embodiments of the present disclosure further provide a program, in which, the program is configured to execute the method for managing storage space according to embodiments of the present disclosure when the program is running.

It should be noted that, for the purpose of simple description, the foregoing respective method embodiments are expressed as a series of actions. However, those skilled in the art should appreciate that, the present disclosure is not limited by order of actions described, since depending on the present disclosure, certain steps may be operated in any other order or simultaneously. Secondly, those skilled in the art further should appreciate that, embodiments described in the specification belong to preferable embodiments, and the actions and modules involved may not be necessary for the present disclosure.

In above embodiments, description of respective embodiments has its own emphasis, and for parts not described in detail in a certain embodiment, reference may be made to the description of other embodiments.

In some embodiments provided by the present disclosure, it is to be understood that the disclosed apparatus may be implemented in other ways. For instance, the apparatus embodiments described above are exemplary, for example, the units are divided in terms of logical functions, and can be divided in other ways in actual implementation. For instance, a plurality of units or components may be combined or may be integrated into another system, or some features may be ignored, or may not be executed. In addition, the displayed or discussed mutual coupling or direct coupling or communication connection may be connected via some interfaces, indirect coupling or communication connection of the devices or units may be in an electrical form or in other forms.

The units described as separate parts may be or may not be physically separated, the components displayed as units may be or may not be physical units, that is, may be located in one place, or may be distributed on a purity of network units. Some or all of the units may be selected according to actual needs to achieve the objective of the solution of this embodiment.

In addition, respective function units in respective embodiments of the present disclosure can be integrated in one processing unit, or respective unit can also exist physically alone, or two or more units may be integrated in one unit. The foregoing integrated unit may be implemented either in hardware or software functional units.

If the integrated unit is implemented as a software functional unit and is sold or used as a stand-alone product, it may be stored in a computer readable storage medium. Based on this understanding, substantial parts or parts that contribute to the related art of the technical solution of the present disclosure or all or parts of the technical solution can be embodied in a form of software product. The computer software product is stored in a storage medium, and includes several instructions to enable a computer device (which may be a personal computer, a server or a network device and the like) to execute all or a part of steps of the methods according to respective embodiments of the present disclosure. The foregoing storage medium includes a U disk, a ROM (Read-Only Memory), a RAM (Random Access Memory), a mobile hard disk, a magnetic disk, an optical disk and other various mediums that may be store program codes.

As described above, the foregoing embodiments are merely used to illustrate the technical solution of the present disclosure, and are not used to limit the present disclosure. Although the present disclosure has been described in detail with reference to the foregoing embodiments, those skilled in the art should understand that, the technical solutions described in respective embodiments above may be modified, or some of technical features may be equivalently replaced; however, these modifications or replacements do not deviate the essence of the corresponding technical solutions from the scope of the technical solutions of embodiments of the present disclosure.

What is claimed is:

1. A method for managing storage space, comprising:
obtaining a first operation instruction for managing storage space, wherein the first operation instruction is configured to instruct to display a storage space management window;
displaying the storage space management window, and displaying newly added storage amounts of respective applications within a preset time period in the storage space management window, wherein the preset time period is from the last time of displaying the storage space management window before deleting data in the storage space to this time of displaying the storage space management window.

2. The method according to claim 1, wherein, displaying the storage space management window comprises:
displaying names and/or icons, and the newly added storage amounts of respective applications in the storage space management window according to a descending order of the newly added storage amounts.

3. The method according to claim 1, wherein, after displaying the storage space management window, the method further comprises:
obtaining a second operation instruction for displaying a storage file information window j corresponding to an application i, wherein, the application i is any of the applications displayed in the storage space management window;
displaying the storage file information window j corresponding to the application i, and displaying the newly added storage amount of the application i within the preset time period in the storage file information window j.

4. The method according to claim 3, wherein, when the application i corresponds to a plurality of storage files, the storage file information window j further comprises at least one control button configured to delete data in a certain storage file.

5. An apparatus for managing storage space, comprising:
a processor; and
a memory, configured to store executable program codes,
wherein the processor is configured to run a program corresponding to the executable program codes by reading the executable program codes stored in the memory, so as to:
obtain a first operation instruction for managing storage space, wherein the first operation instruction is configured to instruct to display a storage space management window;
display the storage space management window, and display newly added storage amounts of respective applications within a preset time period in the storage space management window, wherein the preset time period is from the last time of displaying the storage space management window before deleting data in the storage space to this time of displaying the storage space management window.

6. The apparatus according to claim 5, wherein, the processor is configured to display names and/or icons and the newly added storage amounts of respective applications in the storage space management window according to a descending order of the newly added storage amounts.

7. The apparatus according to claim 5, wherein the processor is further configured to:
obtain a second operation instruction for displaying a storage file information window j corresponding to an application i after displaying the storage space management window, wherein, the application i is any of the applications displayed in the storage space management window;
display the storage file information window j corresponding to the application i, and display a newly added storage amount of the application i within the preset time period in the storage file information window j.

8. The apparatus according to claim 7, wherein, the processor is further configured to:
display in the storage file information window j, at least one control button configured to delete data in a certain storage file, when the application i corresponds to a plurality of storage files.

9. An electronic device, comprising a processor, a memory, a communication interface and a bus, wherein
the processor, the memory and the communication interface are connected with each other and communicate with each other via the bus;
the memory is configured to store executable program codes;
the processor is configured to run a program corresponding to the executable program codes by reading the executable program codes stored in the memory, to execute a method for managing storage space, wherein the method for managing storage space comprises:
obtaining a first operation instruction for managing storage space, wherein the first operation instruction is configured to instruct to display a storage space management window;
displaying the storage space management window, and displaying newly added storage amounts of respective applications within a preset time period in the storage space management window, wherein the preset time period is from the last time of displaying the storage space management window before deleting data in the storage space to this time of displaying the storage space management window.

10. The electronic device according to claim 9, wherein displaying the storage space management window comprises:
displaying names and/or icons, and the newly added storage amounts of respective applications in the storage space management window according to a descending order of the newly added storage amounts.

11. The electronic device according to claim 9, wherein, after displaying the storage space management window, the method further comprises:
obtaining a second operation instruction for displaying a storage file information window j corresponding to an application i, wherein, the application i is any of the applications displayed in the storage space management window;
displaying the storage file information window j corresponding to the application i, and displaying the newly added storage amount of the application i within the preset time period in the storage file information window j.

12. The electronic device according to claim 11, wherein, when the application i corresponds to a plurality of storage files, the storage file information window j further comprises at least one control button configured to delete data in a certain storage file.
